(19) United States
(12) Patent Application Publication
(10) Pub. No.: US 2007/0284843 A1
(43) Pub. Date: Dec. 13, 2007

(54) Fork for simultaneously hand-pedaled and foot-pedaled therapeutic tricycle

(75) Inventor: John Joseph Copeland, High Point, NC (US)

Correspondence Address: James T. Robinson;Exclusivity-Law, Inc., 222 East Main Street, Norman, OK, 73069-1303, US

(73) Assignee: National Ambucs, Inc.

(21) Appl. No.: 11/451,523

(22) Filed: Jun. 12, 2006

(51) Int. Cl. B62M 1/00

(52) U.S. Cl. 280/234; 280/282

(57) ABSTRACT

A therapeutic tricycle for use by children with developmental disabilities includes both hand pedals and foot pedals connected by a drive chain. The foot pedals are connected to a fork tube, partially enclosed within a support tube and driven by a foot pedal sprocket. The hand pedals are supported by a head tube, slidably received within the fork tube and attached to a hand pedal sprocket. A chain tension adjustment assembly permits adjustment of the drive chain tension. A slot in the bottom of the head tube engages a transverse within the fork tube so the head tube and the fork tube remain in fixed relationship, thereby holding the chain sprockets in co-planar alignment.

### BACKGROUND OF THE INVENTION

1. Background

This invention relates to a therapeutic tricycle equipped with both a hand pedal sprocket and a foot pedal sprocket simultaneously driven by a single drive chain and, more specifically but not by way of limitation, to a fork which maintains proper alignment between the hand pedal sprocket and the foot pedal sprocket. The alignment of the hand pedal sprocket and the foot pedal sprocket is also referred to herein, from time to time, as registration.

2. Discussion

Many children receive developmental benefits associated with the operation of a tricycle. Unfortunately, children with developmental disabilities are often unable to ride a tricycle, due either to lack of function in their upper body, especially arms and hands, or lack of function in their lower body, particularly legs and feet. For some years now, a therapeutic tricycle has been available for use in appropriate cases as determined by a professional therapist. The therapeutic tricycle works with a continuous chain mechanism that moves the hands and feet together. This allows the stronger limbs to help the weaker limbs and build strength and stamina. For years, the AmTryke therapeutic tricycle has benefitted and delighted children with disabilities. In addition to the obvious physical benefits, the therapeutic tricycle gives children the opportunity to experience the fun and independence of riding a bicycle with their siblings and friends.

The AmTryke therapeutic tricycle, which is hand and/or foot powered, improves motor coordination, increases self-esteem and is fun to ride! Physical and occupational therapists acknowledge the AmTryke tricycle's therapeutic benefits to patients, citing improved motor skills and strength development.

The presence of both hand pedals and foot pedals, while beneficial to children with developmental disabilities, requires registration (i.e., proper alignment) of the hand pedal sprocket and the foot pedal sprocket. Even a slight deviation from proper alignment can product a derailed drive chain.

### SUMMARY OF THE INVENTION

A therapeutic tricycle for use by children with developmental disabilities provides a frame connecting a rear assembly, which includes a pair of rear wheels, and a front assembly which includes both hand pedals and foot pedals connected by a drive chain. The foot pedals are connected to a fork tube, partially enclosed within the support tube and driven by a foot pedal sprocket. The hand pedals are supported by a head tube, slidably received within the fork tube and attached to a hand pedal sprocket. A chain tension adjustment assembly permits adjustment of the drive chain tension. A slot in the bottom of the head tube engages a transverse within the fork tube so the head tube and the fork tube remain in fixed relationship, thereby holding the sprockets in co-planar alignment.

### BRIEF DESCRIPTION OF THE DRAWINGS

FIG. 1 is a view of a therapeutic tricycle according to the present invention.

FIG. 2 is a side view of the therapeutic tricycle shown in FIG. 1 with the frame, seat, and rear wheels cut away.

FIG. 3 is a front view of the therapeutic tricycle shown in FIG. 1 with the frame, seat, and rear wheels cut away.

FIG. 4 is an enlarged detail view of the support tube, partially cut away to show the interlocking head tube and fork tube.

FIG. 5 is an enlarged detail view of the interlocking head tube and fork tube.

### DETAILED DESCRIPTION

In the following description of the of the present invention, like numerals and characters designate like elements throughout the figures of the drawings.

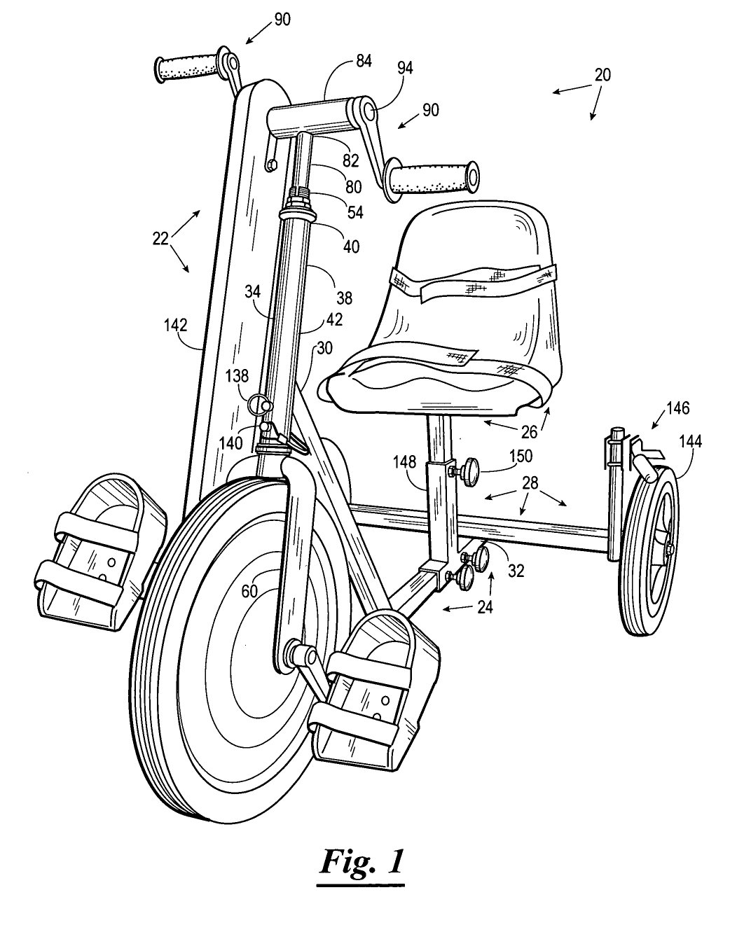

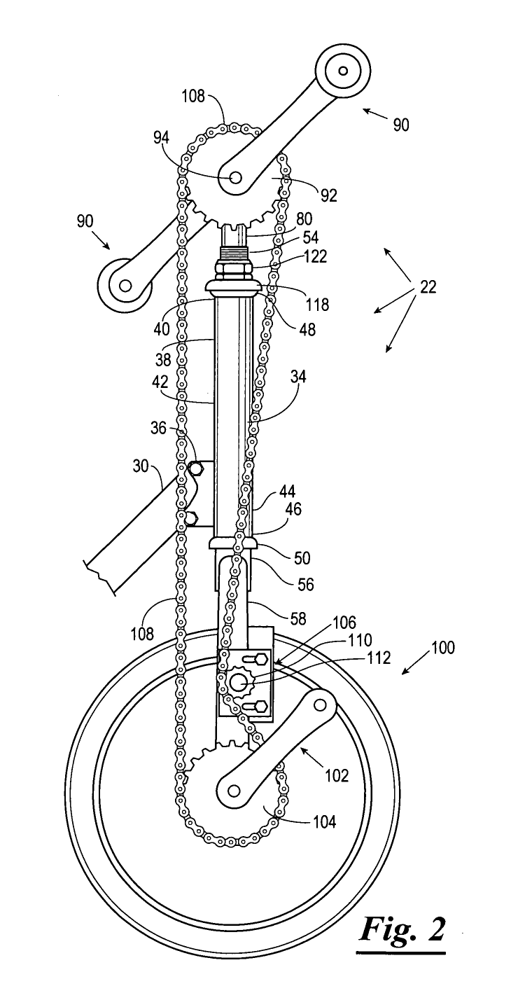

Referring generally to FIGS. 1-5, a therapeutic tricycle 20 has a front assembly 22, an inverted frame assembly 24, a seat assembly 26, and a rear assembly 28. The inverted frame assembly 24 has a front end portion 30 (See FIG. 2) and a rear end portion 32. The front assembly includes a support tube 34 and a frame attachment member 36. The front end portion 30 of the frame assembly 24 is attached to the frame attachment member 36. The rear wheel assembly 28 is attached to the rear end portion 32 of inverted frame assembly 24.

Still referring to FIGS. 1-5, the support tube 34 has an upper portion 38 terminating in a top end 40, an intermediate portion 42, and a lower portion 44 terminating in a bottom end 46. The top end 40 includes an upper bearing flange 48, and the bottom end 46 includes a lower bearing flange 50.

Referring now to FIGS. 1-3, the support tube 34 supports a partially enclosed fork tube 52. The fork tube has a slotted and threaded top end 54 and a lower end 56 (See FIG. 5). The top end 54 of the fork tube 52 extends upwardly from the top end 40 of the support tube 34. The lower end 56 of the fork tube 52 extends downwardly from the bottom end 46 of the support tube 34 and supports two fork members 58, 60. The lower end 56 of the fork tube includes a race 62 which cooperates with the lower bearing flange 50 of the support tube 34 to enclose a lower caged axial ball bearing 64 (not shown).

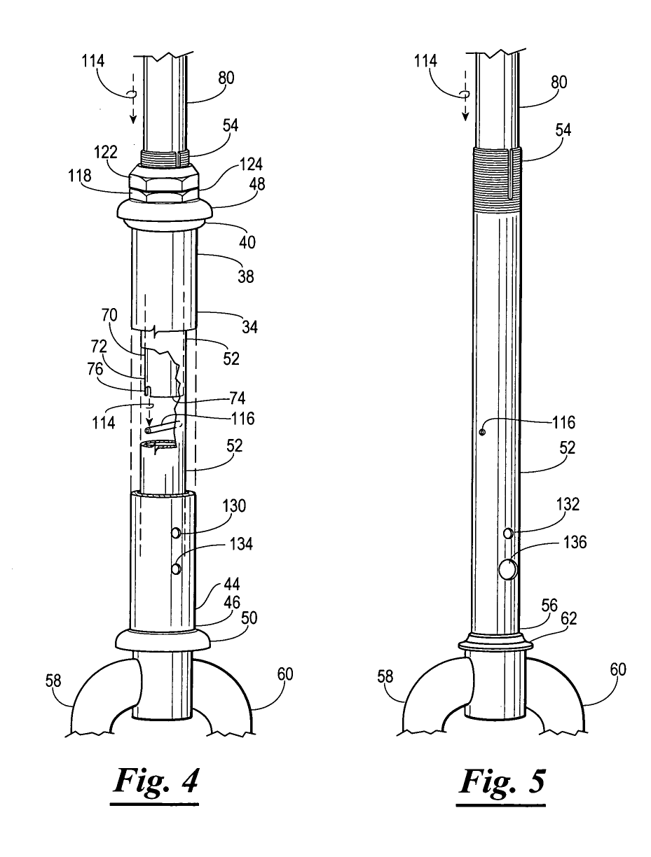

Still referring to FIGS. 1-3, the support tube 34 also supports a partially enclosed head tube 70. The head tube 70 has a lower portion 72 terminating in a lower end 74 with aligned transverse slots 76, 78 (See FIG. 4, only one slot shown). The head tube 70 has an upper portion 80 terminating in an upper end 82. The upper end 82 of the head tube 70 supports a horizontal upper axle tube 84. The upper axle tube 84 supports a hand crank assembly 90. The upper crank assembly 90 (sometimes referred to herein as the hand crank assembly) includes an upper pedal sprocket 92 (sometimes referred to as the hand pedal sprocket) and an upper pedal axle 94 (sometimes referred to as the hand pedal axle). The upper pedal axle 94 is supported at each end by sealed ball bearings (not shown). Because crank assemblies are well known in the art, no further details of the hand crank assembly 90 are necessary.

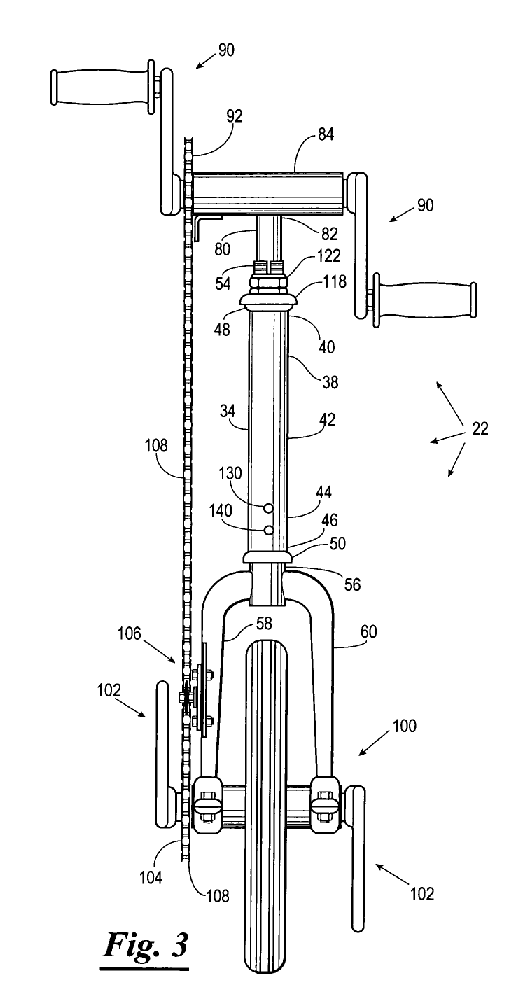

Referring now to FIGS. 2-3, fork members 58, 60 of the front assembly 22 support a front wheel and axle assembly 100 attached to a lower crank assembly 102 (sometimes referred to herein as the foot crank assembly) and a lower pedal sprocket 104 (sometimes referred to as the foot pedal sprocket). Because crank assemblies are well known in the art, no further details of the foot crank assembly 102 are necessary. A chain tensioning member 106 attached to the fork member 58 facilitates tightening of the tension on a chain 108. The chain tensioning assembly 106 includes a chain tensioning sprocket 110 rotatably attached to a stub axle 112.

Referring now to FIG. 3, it will be apparent to one skilled in the art that the upper pedal sprocket 92, the lower pedal sprocket 104, and the chain tensioning sprocket 110 must be properly aligned in a common plane for proper operation of the chain 108. Even a slight deviation from co-planarity can cause the chain to jump off one or more of the sprockets 92, 104, 110 in the path of the drive chain 108.

Referring now to FIGS. 4-5, the present invention provides a fork tube 52 and a head tube 70 which are locked in fixed position so the sprockets 92, 104, and 110 remain in co-planar alignment. The head tube 70 is slidably received within the fork tube 52. As the head tube is moved downwardly in the direction of arrow 114 within the fork tube 52, the aligned slots 76 in the lower portion 72 of the head tube 70 engage a transverse pin 116 in the fork tube 52. The fork tube 52 is secured within the support tube 34 by a flanged support tube nut 118 which cooperates with the flanged end 40 to house an upper caged axial ball bearing 120 (not shown). The head tube 70 is secured within the fork tube 52 by a head tube locking nut 122 attached to the slotted and threaded end 54 of the fork tube 52. For convenience, a washer 124 is placed between the flanged support tube nut 118 and the head tube locking nut 122.

Referring once again to FIGS. 1-5, a pair of aligned bores 130, 132 in the support tube 34 and the fork tube 52, respectively, permit locking of the fork tube 52 by insertion of a pull pin 138 through the aligned bores 130, 132. When the pin 138 is in place, the fork tube 52 will not turn within the support tube 34, and the therapeutic tricycle is limited to forward and backward movement only with no turning of the front wheel and axle assembly 100. A second pair of bores 134, 136 in the support tube 34 and the fork tube 52, respectively, permit insertion of a pull pin 140 to permit only limited radial movement of the fork tube 52 within the support tube 34 because the bore 136 in the fork tube 52 is larger than the bore 134 in the support tube 34. If both pull pins 138, 140 are removed, the fork tube 52 has generally unrestricted radial movement within the support tube 34. A chain guard 142 protects the child with developmental disabilities from injuries related to the chain 108.

The rear assembly 28, attached to the rear portion 32 of the frame 24, includes wheels 144 and a hand brake assembly 146. The seat assembly 26 is adjustably attached to a vertical frame member 148 and secured by a hand knob 150.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

I claim:

1. A therapeutic tricycle for use by children with developmental disabilities, the therapeutic tricycle comprising:
a frame having a front frame portion and a rear frame portion;
a seat attached to the frame;
a rear assembly attached to the rear frame portion of the frame, the rear assembly including a pair of rear wheels;
a front assembly attached to the front frame portion of the frame, the front assembly further comprising:
a support tube having a support tube top portion terminating in a support tube top end, an intermediate portion, and a support tube lower portion terminating in a support tube lower end;
a fork tube having a slotted and threaded top end and a lower end terminating in two fork members supporting a front wheel and axle assembly, wherein the fork tube is partially enclosed within the support tube so the slotted and threaded top end of the fork tube extends upwardly from the top end of the support tube and the fork members extend downwardly from the lower end of the support tube, the fork tube having a transverse pin secured therein at a position between the slotted and threaded top end and the lower end;
a head tube slidably received within the fork tube, the head tube having an upper portion terminating in an upper end and a lower portion terminating in a lower end having aligned transverse slots, so transverse slots in the lower end of the head tube engage the transverse pin within the fork tube, thereby maintaining the fork tube and the head tube in fixed alignment, the head tube having a horizontal axle tube attached to the upper end of the head tube;
an upper crank assembly supported by the upper axle tube, the upper crank assembly having an upper pedal sprocket affixed thereto;
a front wheel and axle assembly supported by the fork members, wherein the front wheel and axle assembly supports a lower crank assembly having a lower pedal sprocket thereto;
a chain tension adjustment assembly having a chain tensioning sprocket rotatable attached to a sub axle supported by the fork member;
a chain connecting the upper pedal sprocket, the lower pedal sprocket, and the chain tensioning sprocket;
means for securing the fork tube within the support tube;
means for securing the head tube within the fork tube; and
wherein the engagement of the transverse pin in the fork tube by the aligned slots in the lower end of the head tube affixes the upper pedal sprocket, the lower pedal sprocket, and the chain tensioning sprocket in co-planar alignment to prevent the chain from disengaging the drive sprockets.

2. A therapeutic tricycle for use by children with developmental disabilities, the therapeutic tricycle comprising:
a frame having a front frame portion and a rear frame portion;
a seat attached to the frame;
a rear assembly attached to the rear frame portion of the frame, the rear assembly including a pair of rear wheels;
a front assembly attached to the front frame portion of the frame, the front assembly further comprising:
a support tube having a support tube top portion terminating in a support tube top end, an intermediate portion, and a support tube lower portion terminating in a support tube lower end;
a fork tube partially enclosed within the support tube so the slotted and threaded top end of the fork tube extends upwardly from the top end of the support tube and the fork members extend downwardly from the lower end of the support tube;
a head tube slidably received within the fork tube, the head tube having an upper portion terminating in an upper end and a lower portion terminating in a lower end, the head tube having a horizontal axle tube attached to the upper end of the head tube;
an upper crank assembly supported by the upper axle tube, the upper crank assembly having an upper pedal sprocket affixed thereto;
a front wheel and axle assembly supported by the fork members, wherein the front wheel and axle assembly supports a lower crank assembly having a lower pedal sprocket thereto;
a chain tension adjustment assembly having a chain tensioning sprocket rotatable attached to a sub axle supported by the fork member;
a chain connecting the upper pedal sprocket, the lower pedal sprocket, and the chain tensioning sprocket;
locking means for locking the head tube in fixed position so the head tube does not rotate within the fork tube;
means for securing the fork tube within the support tube;
means for securing the head tube within the fork tube; and
wherein the engagement of the transverse pin in the fork tube by the aligned slots in the lower end of the head tube affixes the upper pedal sprocket, the lower pedal sprocket, and the chain tensioning sprocket in co-planar alignment to prevent the chain from disengaging the drive sprockets.

3. The device of claim 2, wherein the locking means for locking the head tube in fixed position within the fork tube comprises:
a transverse pin secured within the fork tube at a location between the slotted and threaded top of the fork tube and the lower end of the fork tube;
mating aligned slots in the lower end of the head tube; and
wherein the engagement of the transverse pin in the fork tube by the aligned slots in the lower end of the head tube locks the head tube in fixed position within the fork tube.

4. A fork for use with simultaneously hand-pedaled and foot-pedaled therapeutic tricycle for use by children with developmental disabilities, comprising:
a support tube having a support tube top portion terminating in a support tube top end, a support tube intermediate portion, and a support tube lower portion terminating in a support tube lower end;
a fork tube having a slotted and threaded top end and a lower end terminating in two fork members for supporting a front wheel and axle assembly, the fork tube being partially enclosed within the support tube so the slotted and threaded top end of the fork tube extends upwardly from the top end of the support tube and the fork members extend downwardly from the lower end of the support tube;
a head tube slidably received within the fork tube, the head tube having an upper portion terminating in an upper end and a lower portion terminating in a lower end, the head tube having a horizontal axle tube attached to the upper end of the head tube to support an upper pedal assembly; and
locking means for locking the head tube within the fork tube so the head tube is prevented from rotating within the fork tube.

5. The device of claim 4 wherein the locking means for locking the head tube in fixed position within the fork tube comprises:
a transverse pin secured within the fork tube at a location between the slotted and threaded top of the fork tube and the lower end of the fork tube;
mating aligned slots in the lower end of the head tube; and
wherein the engagement of the transverse pin in the fork tube by the aligned slots in the lower end of the head tube locks the head tube in fixed position within the fork tube.
